(19) United States
(12) Patent Application Publication
(10) Pub. No.: US 2002/0142793 A1
(43) Pub. Date: Oct. 3, 2002

(54) Foldale cellular phone holding set

(76) Inventor: Eagle Fan, Chupei City (TW)

Correspondence Address: Jason Z. Lin, 19597 Via Monte Drive, Saratoga, CA, 95070, US

(21) Appl. No.: 09/825,313

(22) Filed: Apr. 2, 2001

(51) Int. Cl. H04M 1/00

(52) U.S. Cl. 455/550; 455/575; 455/90; 455/569

(57) ABSTRACT

A cellular phone holding set includes a first part pivotally connected to a second part which is pivotally connected to a base. A speaker is received in an inner periphery of the first part and a holding device is connected to the first part. The holding device is located between the first part and the second part so as to hold a cellular phone. The first part is connected to the second part to form a sphere ball or other shapes when no cellular phone is clamped on the holding set.

### FIELD OF THE INVENTION

The present invention relates to a foldable cellular phone holding set comprising two parts pivotally connected with each other and the two parts are combined to a sphere or a specific shape when no cellular phone is received therein.

### BACKGROUND OF THE INVENTION

A conventional cellular phone holding set is generally equipped in a vehicle and designed to hold the cellular phone so that the user does not need to hold the cellular phone during driving. The conventional cellular phone holding set is usually in a form of a clamp with a receiving recess so as to receive the cellular phone therein and the holding set is fixedly connected to a proper position on the panel in a vehicle. However, the conventional holding set has no design on its appearance and is simply focused on its functional feature so that it cannot fit in the interior design of the vehicles.

### SUMMARY OF THE INVENTION

In accordance with one aspect of the present invention, there is provided a cellular phone holding set and comprising a first part pivotally connected to a second part which is pivotally connected to a base. A speaker is received in an inner periphery of the first part and a holding device is located between the first part and the second part.

The primary object of the present invention is to provide a cellular phone holding set which has an aesthetic appearance so that when the holding set is not in use, it may perform as a decoration of the interior of vehicles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a front view to show the cellular phone holding set of the present invention;

FIG. 2 is a side view to show the cellular phone holding set of the present invention;

FIG. 3 is a side view, partly in section, to show the cellular phone holding set of the present invention;

FIG. 4 is a side view, partly in section, to show the cellular phone holding set of the present invention wherein the holding set is closed to form a sphere;

FIGS. 5A and 5B respectively show the holding set is pivoted relative to the base;

FIG. 6 is a rear view to show the cellular phone holding set of the present invention;

FIG. 7 is an exploded view to show a block and an adjustable holding device of the cellular phone holding set of the present invention, and

FIG. 8 is an exploded view to show a block and a fixed-type holding device of the cellular phone holding set of the present invention.

### DETAILED DESCRIPTION OF THE PREFERRED EMBODIMENT

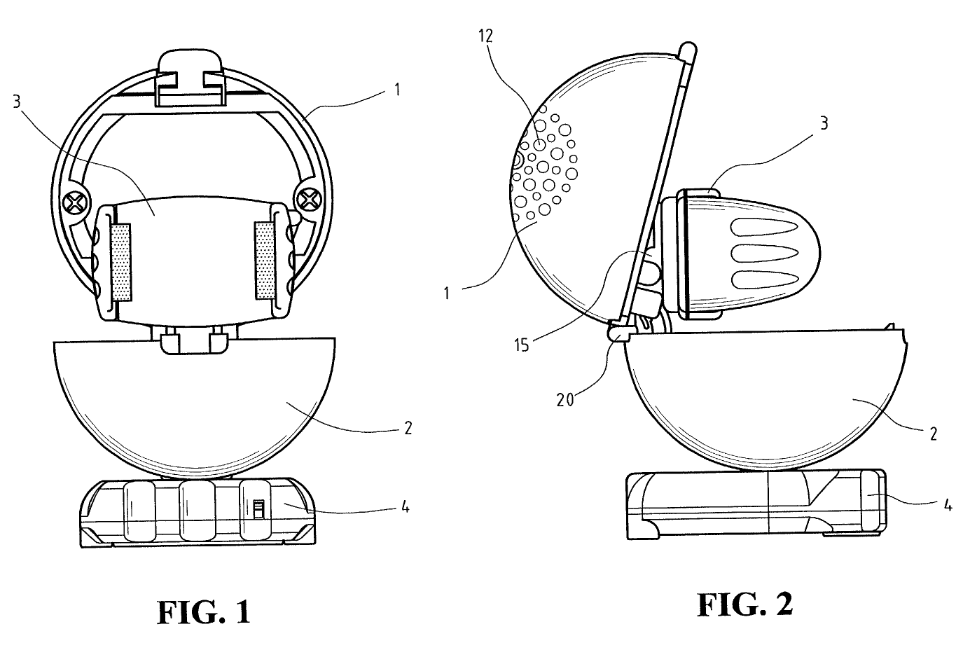

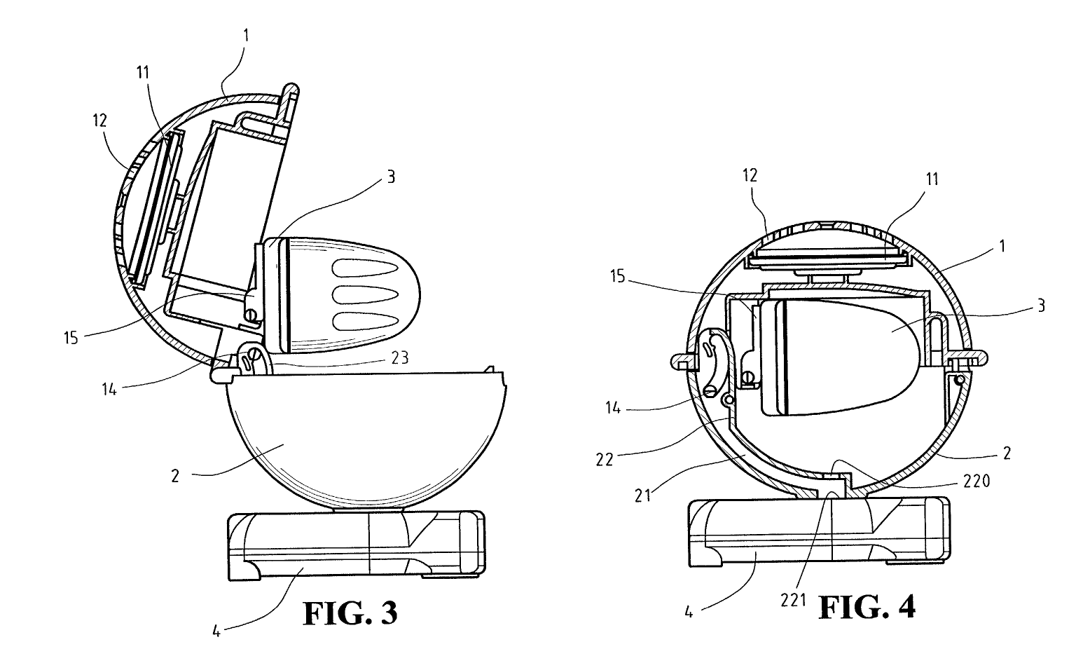

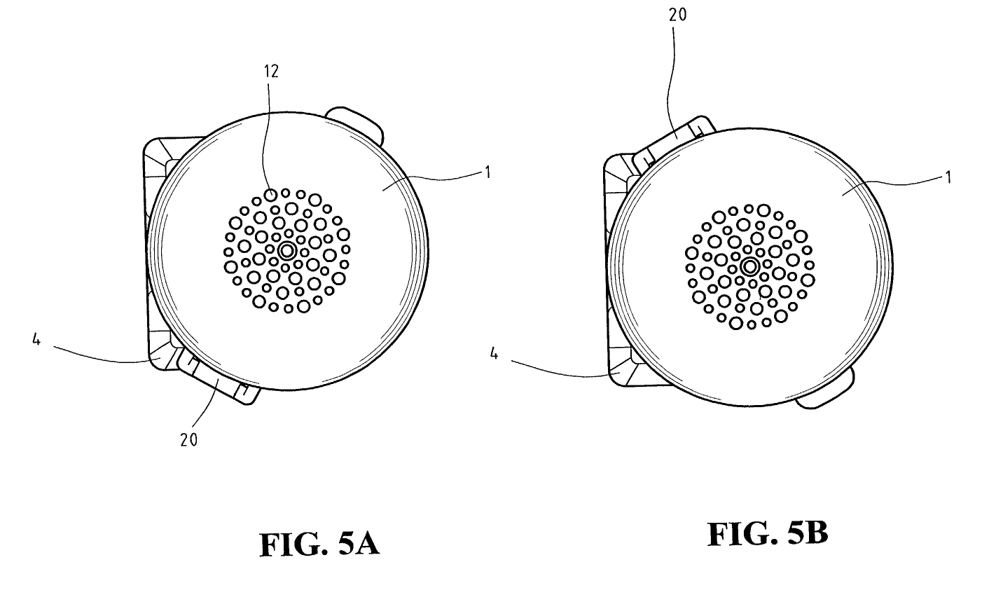

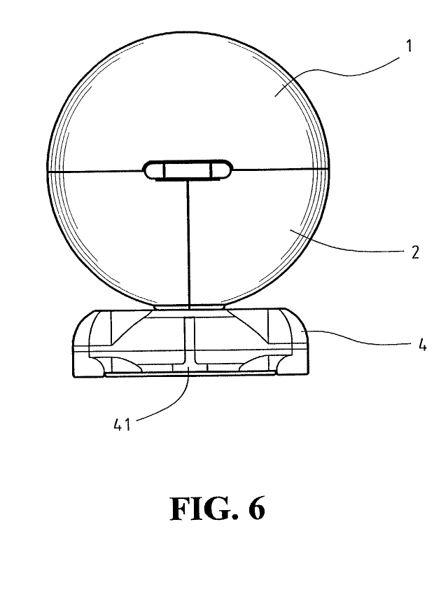

Referring to FIGS. 1 to 4, the cellular phone holding set of the present invention comprises a first part 1 pivotally connected to a second part 2 by a pivotal member 20. Each of the first part 1 and the second part 2 is a half sphere so that when the first part 1 is engaged with the second part 2, the holding set of the present invention is in a form of a sphere as shown in FIG. 4. The shape of the holding set can be modified or made to be any other proper shape such as a golf ball, a soccer ball, or a foot ball. A speaker 11 is received in an inner periphery of the first part 1 and a plurality of apertures 12 are defined through the first part 1 to allow the sound out. A holding device 3 is connected to the inner periphery of the first part 1 and located between the first part 1 and the second part 2. The second part 2 is pivotally connected on a top of a base 4 which is fixed connected to the vehicle. A passage 41 as shown in FIG. 6 is defined through the base 4 so that wires can extend into the holding set via the passage 41. Accordingly, the sphere can be pivoted relative to the base 4 as shown in FIGS. 5A and 5B. By the pivotal action, the first part 1 can be moved to a desired position.

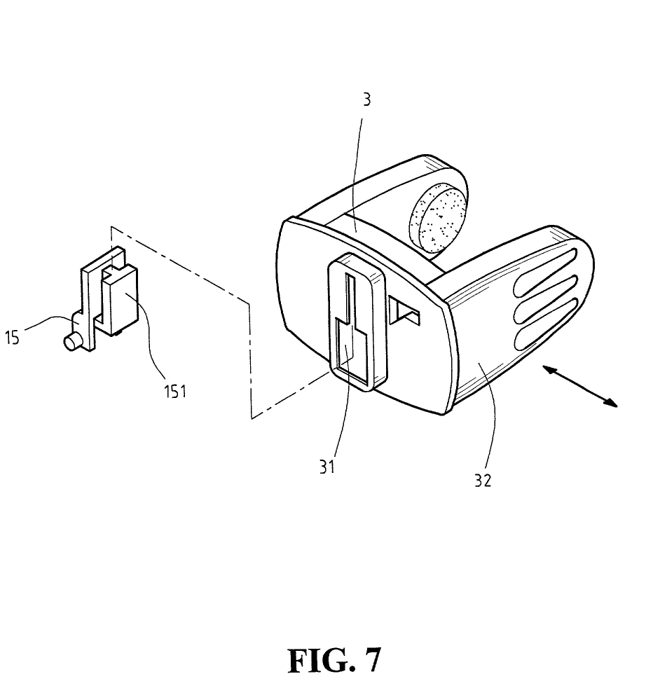

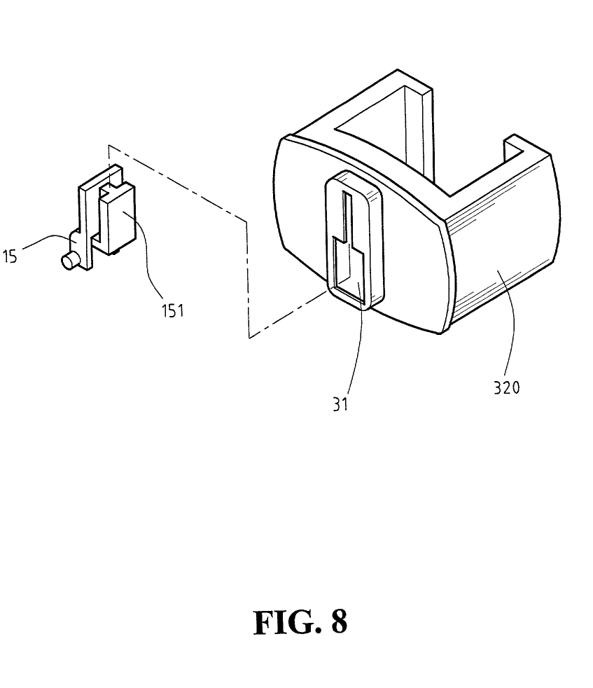

Referring to FIGS. 7 and 8, the holding device 3 includes a base board with two clamping members 32 extending from the base board. One of the clamping members 32 can be movable as shown in FIG. 7 so as to receive cellular phones with different sizes. As shown in FIG. 8 the clamping members 320 are fixed and has a lower manufacturing cost. A box is connected to the base board and has a groove 31 defined therein. A block 15 is connected to the first part 1 and the block 15 has an engaging plate 151 which is movably received in the groove 31.

The second part 2 has two hollow lugs 23 and the first part 1 has two rods 14 which are movably-retained in the two hollow lugs 23. The lugs 23 allow the first part 1 to be opened to a limited position so that the first part 1 will not over-pivoted to prevent the holding set from falling. An inner wall 22 is located in the second part 2 and a space 21 is defined between the inner wall 22 and an inner periphery of the second part 2. A through hole 221 is defined through the second part 2 and communicating with the space 21 so that wires can be extended through the passage 41 and the space 12 via the through hole 221 and connected to the speaker 11. A wire hole 220 is defined through the inner wall 22 and communicates with the space 21 and an interior of the second part 2 so that wires may extend through the passage 41, the through hole 221 and the wire hole 220 and are connected to the cellular phone clamped by the holding device 3.

The holding set can be made to be any shape that fits in the interior design of vehicles.

While we have shown and described various embodiments in accordance with the present invention, it should be clear to those skilled in the art that further embodiments may be made without departing from the scope of the present invention.

What is claimed is:

1. A cellular phone holding set comprising:
a first part pivotally connected to a second part, a speaker received in an inner periphery of said first part and a holding device located between said first part and said second part, and
a base and said second part pivotally connected on a top of said base.

2. The holding set as claimed in claim 1, wherein said second part has two hollow lugs and said first part has two rods, said two rods movably retained in said two hollow lugs.

3. The holding set as claimed in claim 1, wherein said first part has a plurality of apertures defined therethrough.

4. The holding set as claimed in claim 1, further comprising a block connected to said first part and said block having an engaging plate, said holding device including a base board with two clamping members extending from said base board, a box connected to said base board and having a groove defined therein, said engaging plate movably received in said groove.

5. The holding set as claimed in claim 1, further comprising an inner wall in said second part and a space defined between said inner wall and an inner periphery of said second part, a through hole defined through said second part and communicating with said space.

6. The holding set as claimed in claim 5, wherein a wire hole defined through said inner wall and communicates with said space and an interior of said second part.
